(19) United States
(12) Patent Application Publication
(10) Pub. No.: US 2022/0211102 A1
(43) Pub. Date: Jul. 7, 2022

(54) AEROSOL-GENERATING SYSTEM AND AEROSOL-GENERATING ARTICLE COMPRISING AN AEROSOL-GENERATING FILM

(71) Applicant: Philip Morris Products S.A., Neuchatel (CH)

(72) Inventors: Sebastien CAPELLI, Neuchatel (CH); Onur DAYIOGLU, Neuchatel (CH); Jean-Yves VOLLMER, Neuchatel (CH)

(73) Assignee: Philip Morris Products S.A., Neuchatel (CH)

(21) Appl. No.: 17/601,983

(22) PCT Filed: Mar. 18, 2020
(86) PCT No.: PCT/EP2020/057516

§ 371 Date: Oct. 7, 2021

(30) Foreign Application Priority Data
Apr. 8, 2019 (EP) 19168001.6

(51) Int. Cl. A24F 40/30; A24F 40/20; A24D 1/20; A24F 40/57; A24B 15/167; A24F 40/46; A24F 40/465; H05B 1/02

(52) U.S. Cl. CPC A24F 40/30; A24F 40/20; A24D 1/20; A24F 40/57; H05B 2203/005; A24F 40/46; A24F 40/465; H05B 1/0244; A24B 15/167

(57) ABSTRACT

An aerosol-generating system is provided, including: an aerosol-generating film including a cellulose based film-forming agent, a non-cellulose based thickening agent, and a polyhydric alcohol; a heater assembly configured to heat the aerosol-generating film to generate an inhalable aerosol; a power supply; and control circuitry configured to: control a supply of power from the power supply to the heater assembly in response to a user inhalation, and activate the heater assembly to sequentially heat different portions of the aerosol-generating film in response to successive user inhalations, the cellulose based film-forming agent being a cellulose ether. An aerosol-generating article is also provided.

The invention relates to an aerosol-generating system comprising an aerosol-generating film. In particular, the invention relates to a handheld aerosol-generating system that is configured to vaporise an aerosol-generating film by heating to generate an aerosol to be inhaled by a user. The invention also relates to an aerosol-generating article comprising an aerosol-generating film. In particular, the invention relates to an aerosol-generating article comprising an aerosol-generating film for use in a handheld aerosol-generating system that is configured to vaporise the aerosol-generating film by heating to generate an aerosol to be inhaled by a user.

Aerosol-generating articles in which an aerosol-generating substrate, such as a nicotine-containing substrate or a tobacco-containing substrate, is heated rather than combusted, are known in the art. Typically, in such heated aerosol-generating articles an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol. Substrates for heated aerosol-generating articles typically comprise an “aerosol former”, that is, a compound or mixture of compounds that, in use, facilitates formation of the aerosol. Examples of aerosol-formers include: polyhydric alcohols, such as propylene glycol and glycerine.

Known heated aerosol generating articles include, for example, aerosol generating articles that are electrically heated to generate an aerosol and aerosol generating articles in which an aerosol is generated by the transfer of heat from a combustible fuel element or heat source to a physically separate aerosol forming material.

Known handheld electrically operated aerosol-generating systems include, for example, electrically operated aerosol-generating systems that comprise: an aerosol-generating article comprising an aerosol-generating substrate; and an aerosol-generating device comprising a battery, control circuitry and an electric heater for heating the aerosol-generating substrate of the aerosol-generating article to generate an aerosol. In some examples, the electric heater of the aerosol-generating device is inserted into or around the aerosol-generating substrate when the aerosol-generating article is inserted into the aerosol-generating device.

Handheld electrically operated aerosol-generating systems comprising electric heaters that are arranged to sequentially heat different portions of an aerosol-generating substrate to provide individual puffs are also known.

For example, U.S. Pat. No. 5,060,671 discloses an article in which a flavor generating medium is electrically heated to evolve inhalable flavors or other components in vapor or aerosol form. The article has a plurality of charges of the flavor generating medium which are heated sequentially to provide individual puffs. The article comprises electrical heating means for individually heating each of the plurality of charges, a source of electrical energy for powering the electrical heating means, and control means for applying the electrical energy to the electrical heating means to individually heat one of the plurality of charges. Each of the charges, when heated, delivers a quantity of flavor-containing substance to the consumer.

Known aerosol-generating systems may suffer from the problem that the amount of aerosol generated per puff is not consistent. This may be due to variations in the amount of aerosol-generating substrate that is heated to generate the aerosol for each puff or variations in the composition of the aerosol-generating substrate that is heated to generate the aerosol for each puff.

It would be desirable to provide an aerosol-generating system that provides for more consistent aerosol delivery.

In particular, it would be desirable to provide an aerosol-generating system that provides for a controlled and consistent predetermined amount of aerosol to be delivered to a user per puff.

The invention relates to an aerosol-generating system. The aerosol-generating system may comprise an aerosol-generating film. The aerosol-generating film may comprise a cellulose based film-forming agent, a non-cellulose based thickening agent and a polyhydric alcohol. The aerosol-generating system may comprise a heater assembly for heating the aerosol-generating film to generate an inhalable aerosol. The aerosol-generating system may comprise a power supply. The aerosol-generating system may comprise control circuitry. The control circuitry may be configured to control a supply of power from the power supply to the heating assembly in response to a user inhalation. The control circuitry may be configured to activate the heater assembly to sequentially heat different portions of the aerosol-generating film in response to successive user inhalations.

According to a first aspect of the invention there is provided an aerosol-generating system comprising: an aerosol-generating film comprising a cellulose based film-forming agent, a non-cellulose based thickening agent and a polyhydric alcohol; a heater assembly for heating the aerosol-generating film to generate an inhalable aerosol; a power supply; and control circuitry configured to control a supply of power from the power supply to the heating assembly in response to a user inhalation, wherein the control circuitry is configured to activate the heater assembly to sequentially heat different portions of the aerosol-generating film in response to successive user inhalations.

The invention also relates to an aerosol-generating article. The aerosol-generating article may comprise a support. The aerosol-generating article may comprise a plurality of spaced-apart discrete portions of aerosol-generating film disposed on the support. Each spaced-apart discrete portion of aerosol-generating film may comprise a cellulose based film-forming agent, a non-cellulose based thickening agent and a polyhydric alcohol.

According to a second aspect of the invention there is provided an aerosol-generating article comprising: a support; and a plurality of spaced-apart discrete portions of aerosol-generating film disposed on the support, wherein each spaced-apart discrete portion of aerosol-generating film comprises a cellulose based film-forming agent, a non-cellulose based thickening agent and a polyhydric alcohol.

As described further below, aerosol-generating systems according to the first aspect of the invention may comprise an aerosol-generating article according to the second aspect of the invention.

As used herein with reference to the invention, the term “film” is used to describe a solid laminar element having a thickness that is less than the width or length thereof.

As used herein with reference to the invention, the term “aerosol-generating film” is used to describe a film capable of releasing volatile compounds upon heating to generate an aerosol.

The aerosol-generating system according to the invention comprises an aerosol-generating film comprising a combination of a cellulose based film-forming agent, a non-cellulose based thickening agent and a polyhydric alcohol.

It has been observed that inclusion of high levels of polyhydric alcohol, and in particular high levels of glycerine, in liquid film-forming compositions may adversely impact the physical stability of films produced by, for example, casting or extruding and then drying the liquid film-forming compositions.

The inventors have surprisingly found that inclusion of a cellulose based film-forming agent in combination with a non-cellulose based thickening agent allows the formation of aerosol-generating films comprising high levels of polyhydric alcohol, and in particular high levels of glycerine, with improved physically stability.

In particular, the inventors have surprisingly found that inclusion of a cellulose based film-forming agent in combination with a non-cellulose based thickening agent allows the formation of aerosol-generating films comprising high levels of polyhydric alcohol, and in particular high levels of glycerine, that substantially maintain their shape and composition over time when exposed to ambient environmental or storage conditions.

Inclusion of a cellulose based film-forming agent in combination with a non-cellulose based thickening agent allows the formation of aerosol-generating films comprising high levels of polyhydric alcohol, and in particular high levels of glycerine, of predetermined shape, size and composition with high precision and repeatability.

In use, heating of the aerosol-generating film comprising a cellulose based film-forming agent, a non-cellulose based thickening agent and a polyhydric alcohol by the heater assembly of the aerosol-generating system of the invention may generate an inhalable aerosol comprising polyhydric alcohol and, where present in the aerosol-generating film, an alkaloid compound, such as nicotine, or a cannabinoid compound, such as cannabidiol (CBD) or tetrahydrocannabinol (THC), without substantially releasing a liquid phase from the aerosol-generating film.

In use, heating of the aerosol-generating film comprising a cellulose based film-forming agent, a non-cellulose based thickening agent and a polyhydric alcohol by the heater assembly of the aerosol-generating system of the invention to generate an inhalable aerosol may vaporise substantially all of the aerosol-generating film. In particular, heating the aerosol-generating film to a temperature of between about 180 degrees Celsius and about 250 degrees Celsius to generate an inhalable aerosol may vaporise substantially all of the components of the aerosol-generating film other than a small quantity of the cellulose based film-forming agent.

In aerosol-generating systems according to the first aspect of the invention and aerosol-generating articles according to the second aspect of the invention the aerosol delivery per puff may advantageously be precisely and reliably controlled by adjusting the dimensions and composition of the aerosol-generating film.

Inclusion of an aerosol-generating film comprising a cellulose based film-forming agent, a non-cellulose based thickening agent and a polyhydric alcohol in aerosol-generating systems according to the first aspect of the invention and aerosol-generating articles aerosol-generating film thereby enables a consistent aerosol to be generated and delivered to a user over successive user inhalations or puffs.

The aerosol-generating film may be self-supporting. The mechanical and cohesion properties of a self-supporting aerosol-generating film are such that, even if the aerosol-generating film is obtained by, for example, casting a liquid film-forming formulation on a support, the formed aerosol-generating film can be separated from the support.

The aerosol-generating film may be disposed on a support or sandwiched between other materials. This may enhance the mechanical stability of the film.

The aerosol-generating film may have a thickness of less than or equal to about 1 millimetre. For example, the aerosol-generating film may have a thickness of less than or equal to about 0.8 millimetres.

As used herein with reference to the invention, the term “thickness” is used to describe the minimum distance measured between opposite, substantially parallel surfaces of the aerosol-generating film.

As described further below, the aerosol-generating film may be formed by drying a cast or extruded aqueous liquid film-forming composition comprising the cellulose based film-forming agent, the non-cellulose based thickening agent and the polyhydric alcohol. In such embodiments, the cast or extruded aqueous liquid film-forming composition may advantageously substantially not contract during drying, despite the loss of water. As a result, the thickness of the aerosol-generating film may substantially correspond to the thickness of the cast or extruded aqueous liquid film-forming composition.

Preferably, the aerosol-generating film has a thickness of less than or equal to about 0.6 millimetres. More preferably, the aerosol-generating film has a thickness of less than or equal to about 0.4 millimetres. Most preferably, the aerosol-generating film has a thickness of less than or equal to about 0.2 millimetres.

Preferably, the aerosol-generating film has a thickness of at least about 0.05 millimetres. More preferably, the aerosol-generating film has a thickness of at least about 0.075 millimetres. Most preferably, the aerosol-generating film has a thickness of at least about 0.1 millimetres.

The aerosol-generating film may have a thickness of between about 0.05 millimetres and about 1 millimetre. For example, the aerosol-generating film may have a thickness of between about 0.05 millimetres and about 0.8 millimetres.

Preferably, the aerosol-generating film has a thickness of between about 0.05 millimetres and about 0.6 millimetres. For example, the aerosol-generating film has a thickness of between about 0.05 millimetres and about 0.4 millimetres or between about 0.05 millimetres and about 0.2 millimetres.

More preferably, the aerosol-generating film has a thickness of between about 0.075 millimetres and about 0.6 millimetres. For example, the aerosol-generating film has a thickness of between about 0.075 millimetres and about 0.4 millimetres or between about 0.075 millimetres and about 0.2 millimetres.

Most preferably, the aerosol-generating film has a thickness of between about 0.1 millimetres and about 0.6 millimetres. For example, the aerosol-generating film has a thickness of between about 0.1 millimetres and about 0.4 millimetres or between about 0.1 millimetres and about 0.2 millimetres.

Aerosol-generating films having a thickness of between about 0.1 millimetres and about 0.2 millimetres may advantageously exhibit low thermal inertia and good mechanical strength.

Preferably, the aerosol-generating film has a grammage of at least about 60 grams per square metre (gsm). More preferably, the aerosol-generating film has a grammage of at least about 80 gsm. Most preferably, the aerosol-generating film has a grammage of at least about 100 gsm. For example, the aerosol-generating film has a grammage of at least about 120 gsm or of at least about 140 gsm.

Preferably, the aerosol-generating film has a grammage of less than or equal to about 400 gsm. More preferably, the aerosol-generating film has a grammage of less than or equal to about 350 gsm. Most preferably, the aerosol-generating film has a grammage of less than or equal to about 300 gsm. For example, the aerosol-generating film may a grammage of less than or equal to about 280 gsm or less than or equal to about 260 gsm.

Preferably, the aerosol-generating film has a grammage of between about 60 gsm and about 400 gsm. For example, the aerosol-generating film may have a grammage of between about 60 gsm and about 350 gsm, between about 60 gsm and about 300 gsm, between about 60 gsm and about 350 gsm, between about 60 gsm and about 300 gsm, between about 60 gsm and about 280 gsm or between about 60 gsm and about 260 gsm.

More preferably, the aerosol-generating film has a grammage of between about 80 gsm and about 400 gsm. For example, the aerosol-generating film may have a grammage of between about 80 gsm and about 350 gsm, between about 80 gsm and about 300 gsm, between about 80 gsm and about 280 gsm or between about 80 gsm and about 260 gsm.

Most preferably, the aerosol-generating film has a grammage of between about 100 gsm and about 400 gsm. For example, the aerosol-generating film may have a grammage of between about 100 gsm and about 350 gsm, between about 100 gsm and about 300 gsm, between about 100 gsm and about 280 gsm or between about 100 gsm and about 260 gsm.

For example, aerosol-generating films having a grammage of between about 120 gsm and about 400 gsm, between about 120 gsm and about 350 gsm, between about 120 gsm and about 300 gsm, between about 120 gsm and about 280 gsm or between about 120 gsm and about 260 gsm.

For example, aerosol-generating films having a grammage of between about 140 gsm and about 400 gsm, between about 140 gsm and about 350 gsm, between about 140 gsm and about 300 gsm, between about 140 gsm and about 280 gsm or between about 140 gsm and about 260 gsm.

In embodiments in which the aerosol-generating film is self-supporting, the weight of the aerosol-generating film may be measured directly by weighing the aerosol-generating film.

In embodiments in which the aerosol-generating film is disposed on a support, the weight of the aerosol-generating film may be calculated by weighing the support prior to disposing the aerosol-generating film thereon, subsequently weighing the support with the aerosol-generating film disposed thereon and then subtracting the weight of the support from the combined weight of the aerosol-generating film and the support.

In embodiments in which the aerosol-generating film is sandwiched between other materials, the weight of the aerosol-generating film may similarly be calculated by subtracting the weight of the other materials from the combined weight of the aerosol-generating film support and the other materials.

In embodiments in which the aerosol-generating film is formed by drying a cast or extruded aqueous liquid film-forming composition comprising the cellulose based film-forming agent, the non-cellulose based thickening agent and the polyhydric alcohol, the weight of the aerosol-generating film will generally correspond to the weight of the components of the aqueous liquid film-forming composition minus the weight of water evaporated during drying of the cast or extruded aqueous liquid film-forming composition.

The aerosol-generating film comprises a cellulose based film-forming agent, a non-cellulose based thickening agent and a polyhydric alcohol.

As used herein with reference to the invention, the term “cellulose based film-forming agent” is used to describe a cellulosic polymer capable, by itself or in the presence of a non-cellulose based thickening agent, of forming a continuous film.

Preferably, the cellulose based film-forming agent is a cellulose ether.

As used herein with reference to the invention, the term “non-cellulose based thickening agent” is used to describe a non-cellulosic substance that, when added to an aqueous or non-aqueous liquid film-forming composition, increases the viscosity of the liquid film-forming composition without substantially modifying its other properties. The non-cellulose based thickening agent may increase stability and improve suspension of components in the liquid film-forming composition. A thickening agent may also be referred to as a “thickener” or a “rheology modifier”.

Unless stated otherwise, percentages by weight of components of the aerosol-generating film recited herein are based on the total weight of the aerosol-generating film.

The aerosol-generating film may have a cellulose based film-forming agent content of at least about 3 percent by weight or at least about 6 percent by weight.

Preferably, the aerosol-generating film has a cellulose based film-forming agent content of at least about 10 percent by weight. For example, the aerosol-generating film may have a cellulose based film-forming agent content of at least about 12 percent by weight or at least about 14 percent by weight. More preferably, the aerosol-generating film has a cellulose based film-forming agent content of at least about 16 percent by weight. Most preferably, the aerosol-generating film has a cellulose based film-forming agent content of at least about 18 percent by weight.

The aerosol-generating film may have a cellulose based film-forming agent content of less than or equal to about 70 percent by weight or less than or equal to about 50 percent by weight.

Preferably, the aerosol-generating film has a cellulose based film-forming agent content of less than or equal to about 26 percent by weight. More preferably, the aerosol-generating film has a cellulose based film-forming agent content of less than or equal to about 24 percent by weight. Most preferably, the aerosol-generating film has a cellulose based film-forming agent content of less than or equal to about 22 percent by weight.

The aerosol-generating film may have a cellulose based film-forming agent content of between about 3 percent by weight and about 70 percent by weight. For example, the aerosol-generating film may have a cellulose based film-forming agent content of between about 3 percent by weight and about 50 percent by weight.

The aerosol-generating film may have a cellulose based film-forming agent content of between about 6 percent by weight and about 70 percent by weight. For example, the aerosol-generating film may have a cellulose based film-forming agent content of between about 6 percent by weight and about 50 percent by weight.

Preferably, the aerosol-generating film has a cellulose based film-forming agent content of between about 10 percent by weight and about 26 percent by weight. For example, the aerosol-generating film may have a cellulose based film-forming agent content of between about 10 percent by weight and about 24 percent by weight or between about 10 percent by weight and about 22 percent by weight.

More preferably, the aerosol-generating film has a cellulose based film-forming agent content of between about 16 percent by weight and about 26 percent by weight. For example, the aerosol-generating film may have a cellulose based film-forming agent content of between about 16 percent by weight and about 24 percent by weight or between about 16 percent by weight and about 22 percent by weight.

Most preferably, the aerosol-generating film has a cellulose based film-forming agent content of between about 18 percent by weight and about 26 percent by weight. For example, the aerosol-generating film may have a cellulose based film-forming agent content of between about 18 percent by weight and about 24 percent by weight or between about 18 percent by weight and about 22 percent by weight.

Preferably, the aerosol-generating film comprises one or more cellulose based film-forming agents selected from the group consisting of hydroxypropyl methyl cellulose (HPMC), methyl cellulose (MC), ethyl cellulose (EC), hydroxyethyl methyl cellulose (HEMC), hydroxyethyl cellulose (HEC) and hydroxypropyl cellulose (HPC).

More preferably, the aerosol-generating film comprises one or more cellulose based film-forming agents selected from the group consisting of hydroxypropyl methyl cellulose (HPMC), methyl cellulose (MC) and ethyl cellulose (EC).

Most preferably, the aerosol-generating film comprises hydroxypropyl methyl cellulose (HPMC).

Preferably, the aerosol-generating film has a non-cellulose based thickening agent content of at least about 1 percent by weight. More preferably, the aerosol-generating film has a non-cellulose based thickening agent content of at least about 2 percent by weight. Most preferably, the aerosol-generating film has a non-cellulose based thickening agent content of at least about 3 percent by weight.

The aerosol-generating film may have a non-cellulose based thickening agent content of less than or equal to about 50 percent by weight or less than or equal to about 25 percent by weight.

Preferably, the aerosol-generating film has a non-cellulose based thickening agent content of less than or equal to about 10 percent by weight. More preferably, the aerosol-generating film has a non-cellulose based thickening agent content of less than or equal to about 8 percent by weight. Most preferably, the aerosol-generating film has a non-cellulose based thickening agent content of less than or equal to about 6 percent by weight.

The aerosol-generating film may a non-cellulose based thickening agent content of between about 1 percent by weight and about 50 percent by weight or between about 1 percent by weight and about 25 percent by weight.

Preferably, the aerosol-generating film has a non-cellulose based thickening agent content of between about 1 percent by weight and about 10 percent by weight. For example, the aerosol-generating film may have a non-cellulose based thickening agent content of between about 1 percent by weight and about 8 percent by weight or between about 1 percent by weight and about 6 percent by weight.

More preferably, the aerosol-generating film has a non-cellulose based thickening agent content of between about 2 percent by weight and about 10 percent by weight. For example, the aerosol-generating film may have a non-cellulose based thickening agent content of between about 2 percent by weight and about 8 percent by weight or between about 2 percent by weight and about 6 percent by weight.

More preferably, the aerosol-generating film has a non-cellulose based thickening agent content of between about 3 percent by weight and about 10 percent by weight. For example, the aerosol-generating film may have a non-cellulose based thickening agent content of between about 3 percent by weight and about 8 percent by weight or between about 3 percent by weight and about 6 percent by weight.

Suitable non-cellulose based thickening agents for inclusion in the aerosol-generating film include, but are not limited to, polysaccharide gelling agents and natural gums.

Preferably, the aerosol-generating film comprises one or more non-cellulose based thickening agents selected from the group consisting of agar, alginate, xanthan gum, gellan gum, guar gum, gum Arabic, locust bean gum, carrageenan, pectin and starch.

More preferably, the aerosol-generating film comprises one or more non-cellulose based thickening agents selected from the group consisting of agar, alginate and xanthan gum.

Most preferably, the aerosol-generating film comprises agar.

The aerosol-generating film may have a polyhydric alcohol content of at least about 25 percent by weight. For example, the aerosol-generating film may have a polyhydric alcohol content of at least about 30 percent by weight.

Preferably, the aerosol-generating film has a polyhydric alcohol content of at least about 40 percent by weight. More preferably, the aerosol-generating film has a polyhydric alcohol content of at least about 42 percent by weight. Most preferably, the aerosol-generating film has a polyhydric alcohol content of at least about 44 percent by weight.

Preferably, the aerosol-generating film has a polyhydric alcohol content of less than or equal to about 90 percent by weight. More preferably, the aerosol-generating film has a polyhydric alcohol content of less than or equal to about 85 percent by weight. Most preferably, the aerosol-generating film has a polyhydric alcohol content of less than or equal to about 80 percent by weight.

The aerosol-generating film may have a polyhydric alcohol content of between about 25 percent by weight and about 90 percent by weight. For example, the aerosol-generating film may have a polyhydric alcohol content of between about 30 percent by weight and about 90 percent by weight.

Preferably, the aerosol-generating film has a polyhydric alcohol content of between about 40 percent by weight and about 90 percent by weight. For example, the aerosol-generating film may have a polyhydric alcohol content of between about 40 percent by weight and about 85 percent by weight or between about 40 percent by weight and about 80 percent by weight.

More preferably, the aerosol-generating film has a polyhydric alcohol content of between about 42 percent by weight and about 90 percent by weight. For example, the aerosol-generating film may have a polyhydric alcohol content of between about 42 percent by weight and about 85 percent by weight or between about 42 percent by weight and about 80 percent by weight.

Most preferably, the aerosol-generating film has a polyhydric alcohol content of between about 44 percent by weight and about 90 percent by weight. For example, the aerosol-generating film may have a polyhydric alcohol content of between about 44 percent by weight and about 85 percent by weight or between about 44 percent by weight and about 80 percent by weight.

Preferably, the aerosol-generating film comprises one or more polyhydric alcohols selected from the group consisting of 1,3-butanediol, glycerine, propylene glycol, and triethylene glycol.

More preferably, the aerosol-generating film comprises one or more polyhydric alcohols selected from the group consisting of glycerine and propylene glycol.

Most preferably, the aerosol-generating film comprises glycerine.

Preferably, the ratio of the weight percent of cellulose based film-forming agent to the weight percent of polyhydric alcohol in the aerosol-generating film is at least about 0.1, more preferably at least about 0.2, most preferably at least about 0.3.

Preferably, the ratio of the weight percent of cellulose based film-forming agent to the weight percent of polyhydric alcohol in the aerosol-generating film is less than or equal to about 1.

Preferably, the ratio of the weight percent of cellulose based film-forming agent to the weight percent of polyhydric alcohol in the aerosol-generating film is between about 0.1 and about 1, more preferably between about 0.2 and about 1, most preferably between about 0.3 and about 1.

Preferably, the ratio of the weight percent of non-cellulose based thickening agent to the weight percent of polyhydric alcohol in the aerosol-generating film is at least about 0.05, more preferably at least 0.1, most preferably at least 0.2.

Preferably, the ratio of the weight percent of non-cellulose based thickening agent to the weight percent of polyhydric alcohol in the aerosol-generating film is less than or equal to about to 0.5.

Preferably, the ratio of the weight percent of non-cellulose based thickening agent to the weight percent of polyhydric alcohol in the aerosol-generating film is between about 0.05 and about 0.5, more preferably between about 0.1 and about 0.5, most preferably between about 0.2 and about 0.5.

In certain preferred embodiments, the aerosol-generating film may comprise HPMC and glycerine.

In such embodiments, preferably the ratio of the weight percent of HPMC to the weight percent of glycerine in the aerosol-generating film is at least about 0.1, more preferably at least about 0.2, most preferably at least about 0.3.

Preferably, the ratio of the weight percent of HPMC to the weight percent of glycerine in the aerosol-generating film is less than or equal to about 1.

Preferably, the ratio of the weight percent of HPMC to the weight percent of glycerine in the aerosol-generating film is between about 0.1 and about 1, more preferably between about 0.2 and about 1, most preferably between about 0.3 and about 1.

In certain preferred embodiments, the aerosol-generating film may comprise agar and glycerine.

In such embodiments, preferably the ratio of the weight percent of agar to the weight percent of glycerine in the aerosol-generating film is at least about 0.05, more preferably at least 0.1, most preferably at least 0.2.

Preferably, the ratio of the weight percent of agar to the weight percent of glycerine in the aerosol-generating film is less than or equal to about to 0.5.

Preferably, the ratio of the weight percent of agar to the weight percent of glycerine in the aerosol-generating film is between about 0.05 and about 0.5, more preferably between about 0.1 and about 0.5, most preferably between about 0.2 and about 0.5.

In certain particularly preferred embodiments, the aerosol-generating film may comprise HPMC, agar and glycerine.

Preferably, the aerosol-generating film comprises water.

Preferably, the aerosol-generating film has a water content of less than or equal to about 30 percent by weight.

Preferably, the aerosol-generating film has a water content of between about 10 percent by weight and about 20 percent by weight.

The aerosol-generating film may comprise an alkaloid compound, or a cannabinoid compound, or both an alkaloid compound and a cannabinoid compound. The aerosol-generating film may comprise one or more alkaloids. The aerosol-generating film may comprise one or more cannabinoids. The aerosol-generating film may comprise a combination of one or more alkaloids and one or more cannabinoids.

As used herein with reference to the invention, the term “alkaloid compound” is used to describe any one of a class of naturally occurring organic compounds that contain one or more basic nitrogen atoms. Generally, an alkaloid compound contains at least one nitrogen atom in an amine-type structure. This or another nitrogen atom in the molecule of the alkaloid compound can be active as a base in acid-base reactions. Most alkaloid compounds have one or more of their nitrogen atoms as part of a cyclic system, such as for example a heterocyclic ring. In nature, alkaloid compounds are found primarily in plants, and are especially common in certain families of flowering plants. However, some alkaloid compounds are found in animal species and fungi. As used herein with reference to the invention, the term “alkaloid compound” is used to describe both naturally derived alkaloid compounds and synthetically manufactured alkaloid compounds.

The aerosol-generating film may comprise one or more alkaloid compounds selected from the group consisting of nicotine and anatabine.

The aerosol-generating film may comprise nicotine.

As used herein with reference to the invention, the term “nicotine-containing aerosol-generating film” describes an aerosol-generating film comprising nicotine.

As used herein with reference to the invention, the term “nicotine” is used to describe nicotine, nicotine base or a nicotine salt. In embodiments in which the aerosol-generating film comprises a nicotine base or a nicotine salt, the amounts of nicotine recited herein are the amount of free base nicotine or amount of protonated nicotine, respectively.

The aerosol-generating film may comprise naturally derived nicotine or synthetically manufactured nicotine.

As used herein with reference to the invention, the term “cannabinoid compound” is used to describe any one of a class of naturally occurring compounds that are found in parts of the cannabis plant—namely the species Cannabis sativa, Cannabis indica, and Cannabis ruderalis. Cannabinoid compounds are especially concentrated in the female flower heads. Cannabinoid compounds naturally occurring in the cannabis plant include cannabidiol (CBD) and tetrahydrocannabinol (THC). As used herein with reference to the invention, the term “cannabinoid compounds” is used to describe both naturally derived cannabinoid compounds and synthetically manufactured cannabinoid compounds.

The aerosol-generating film may comprise one or more cannabinoid compounds selected from the group consisting of cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM) and cannabielsoin (CBE), cannabicitran (CBT).

The aerosol-generating film may comprise one or more cannabinoid compounds selected from the group consisting of cannabidiol (CBD) and THC (tetrahydrocannabinol).

The aerosol-generating film may comprise cannabidiol (CBD).

The aerosol-generating film may comprise nicotine and cannabidiol (CBD).

The aerosol-generating film may comprise nicotine, cannabidiol (CBD), and THC (tetrahydrocannabinol).

The aerosol-generating film may comprise one or more monoprotic nicotine salts.

As used herein with reference to the invention, the term “monoprotic nicotine salt” is used to describe a nicotine salt of a monoprotic acid.

In embodiments in which the aerosol-generating film comprises an alkaloid compound, or a cannabinoid compound, or both an alkaloid compound and a cannabinoid compound, preferably the aerosol-generating film has a combined alkaloid compound and cannabinoid compound content of at least about 0.5 percent by weight. More preferably, the aerosol-generating film has a combined alkaloid compound and cannabinoid compound content of at least about 1 percent by weight. Most preferably, the aerosol-generating film has a combined alkaloid compound and cannabinoid compound content of at least about 2 percent by weight.

In embodiments in which the aerosol-generating film comprises an alkaloid compound, or a cannabinoid compound, or both an alkaloid compound and a cannabinoid compound, the aerosol-generating film may have a combined alkaloid compound and cannabinoid compound content of less than or equal to about 10 percent by weight.

In embodiments in which the aerosol-generating film comprises an alkaloid compound, or a cannabinoid compound, or both an alkaloid compound and a cannabinoid compound, preferably the aerosol-generating film has a combined alkaloid compound and cannabinoid compound content of less than or equal to about 6 percent by weight. More preferably, the aerosol-generating film has a combined alkaloid compound and cannabinoid compound content of less than or equal to about 5 percent by weight. Most preferably, the aerosol-generating film has a combined alkaloid compound and cannabinoid compound content of less than or equal to about to about 4 percent by weight.

In embodiments in which the aerosol-generating film comprises an alkaloid compound, or a cannabinoid compound, or both an alkaloid compound and a cannabinoid compound, the aerosol-generating film may have a combined alkaloid compound and cannabinoid compound content of between about 0.5 percent by weight and about 10 percent by weight.

In embodiments in which the aerosol-generating film comprises an alkaloid compound, or a cannabinoid compound, or both an alkaloid compound and a cannabinoid compound, preferably the aerosol-generating film has a combined alkaloid compound and cannabinoid compound content of between about 0.5 percent by weight and about 6 percent by weight. For example, the aerosol-generating film may have a combined alkaloid compound and cannabinoid compound content of between about 0.5 percent by weight and about 5 percent by weight or between about 0.5 percent by weight and about 4 percent by weight.

More preferably the aerosol-generating film has a combined alkaloid compound and cannabinoid compound content of between about 1 percent by weight and about 6 percent by weight. For example, the aerosol-generating film may have a combined alkaloid compound and cannabinoid compound content of between about 1 percent by weight and about 5 percent by weight or between about 1 percent by weight and about 4 percent by weight.

Most preferably the aerosol-generating film has a combined alkaloid compound and cannabinoid compound content of between about 2 percent by weight and about 6 percent by weight. For example, the aerosol-generating film may have a combined alkaloid compound and cannabinoid compound content of between about 2 percent by weight and about 5 percent by weight or between about 2 percent by weight and about 4 percent by weight.

In embodiments in which the aerosol-generating film comprises nicotine, preferably the aerosol-generating film has a nicotine content of at least about 0.5 percent by weight. More preferably, the aerosol-generating film has a nicotine content of at least about 1 percent by weight. Most preferably, the aerosol-generating film has a nicotine content of at least about 2 percent by weight.

In embodiments in which the aerosol-generating film comprises nicotine, the aerosol-generating film may have a nicotine content of less than or equal to about 10 percent by weight.

In embodiments in which the aerosol-generating film comprises nicotine, preferably the aerosol-generating film has a nicotine content of less than or equal to about 6 percent by weight. More preferably, the aerosol-generating film has a nicotine content of less than or equal to about 5 percent by weight. Most preferably, the aerosol-generating film has a nicotine content of less than or equal to about to about 4 percent by weight.

In embodiments in which the aerosol-generating film comprises nicotine, the aerosol-generating film may have a nicotine content of between about 0.5 percent by weight and about 10 percent by weight.

In embodiments in which the aerosol-generating film comprises nicotine, preferably the aerosol-generating film has a nicotine content of between about 0.5 percent by weight and about 6 percent by weight. For example, the aerosol-generating film may have a nicotine content of between about 0.5 percent by weight and about 5 percent by weight or between about 0.5 percent by weight and about 4 percent by weight.

More preferably the aerosol-generating film has a nicotine content of between about 1 percent by weight and about 6 percent by weight. For example, the aerosol-generating film may have a nicotine content of between about 1 percent by weight and about 5 percent by weight or between about 1 percent by weight and about 4 percent by weight.

Most preferably the aerosol-generating film has a nicotine content of between about 2 percent by weight and about 6 percent by weight. For example, the aerosol-generating film may have a nicotine content of between about 2 percent by weight and about 5 percent by weight or between about 2 percent by weight and about 4 percent by weight.

The aerosol-generating film may have a tobacco content of less than or equal to about 70 percent by weight, less than or equal to about 50 percent by weight, less than or equal to about 30 percent by weight or less than or equal to about 10 percent by weight.

The aerosol-generating film may be a substantially tobacco-free aerosol-generating film.

As used herein with reference to the invention, the term “substantially tobacco-free aerosol-generating film” describes an aerosol-generating film having a tobacco content of less than 1 percent by weight. For example, the aerosol-generating film may have a tobacco content of less than about 0.75 percent by weight, less than about 0.5 percent by weight or less than about 0.25 percent by weight.

The aerosol-generating film may be a substantially tobacco-free, nicotine-containing aerosol-generating film.

The aerosol-generating film may be a tobacco-free aerosol-generating film.

As used herein with reference to the invention, the term “tobacco-free aerosol-generating film” describes an aerosol-generating film having a tobacco content of 0 percent by weight.

The aerosol-generating film may be a tobacco-free, nicotine-containing aerosol-generating film.

The aerosol-generating film may comprises tobacco plant material or a tobacco plant extract. For example, the aerosol-generating film may comprise tobacco particles, such as tobacco lamina particles.

As used herein with reference to the invention, the term “tobacco-containing aerosol-generating film” describes an aerosol-generating film comprising tobacco plant material or a tobacco extract.

The aerosol-generating film may comprises a non-tobacco plant material or a non-tobacco plant extract. The aerosol-generating film may comprises tobacco material or a non-tobacco plant material or a plant extract. For example, the aerosol-generating film may comprise particles of plants, such as clove and eucalyptus.

The aerosol-generating film may comprise an acid.

Preferably, the aerosol-generating film comprises one or more organic acids.

More preferably, the aerosol-generating film comprises one or more carboxylic acids.

Most preferably, the aerosol-generating film comprises lactic acid or levulinic acid.

The inclusion of an acid is particularly preferred in embodiments in which the aerosol-generating film comprises nicotine. In such embodiments, the presence of an acid may stabilise dissolved species in a liquid film-forming composition from which the aerosol-generating film is formed. Without wishing to be bound by theory, it is believed that the acid may interact with the nicotine, especially where the nicotine is present in the form of a nicotine salt, and that the interaction between the acid and the nicotine may reduce or substantially prevent evaporation of nicotine during drying of the liquid film-forming composition to form the aerosol-generating film. Loss of nicotine during manufacturing of the aerosol-generating film may thereby be minimised. This may advantageously ensure higher and more precisely controlled nicotine delivery to the user.

Preferably, the aerosol-generating film has an acid content of at least about 0.25 percent by weight. More preferably, the aerosol-generating film has an acid content of at least about 0.5 percent by weight. Most preferably, the aerosol-generating film has an acid content of at least about 1 percent by weight.

Preferably, the aerosol-generating film has an acid content of less than or equal to about 3.5 percent by weight. More preferably, the aerosol-generating film has an acid content of less than or equal to about 3 percent by weight. Most preferably, the aerosol-generating film has an acid content of less than or equal to about 2.5 percent by weight.

Preferably, the aerosol-generating film has an acid content of between about 0.25 percent by weight and about 3.5 percent by weight. For example, the aerosol-generating film may have an acid content of between about 0.25 percent by weight and about 3 percent by weight or between about 0.25 percent by weight and about 2.5 percent by weight.

More preferably, the aerosol-generating film has an acid content of between about 0.5 percent by weight and about 3.5 percent by weight. For example, the aerosol-generating film may have an acid content of between about 0.5 percent by weight and about 3 percent by weight or between about 0.5 percent by weight and about 2.5 percent by weight.

Most preferably, the aerosol-generating film has an acid content of between about 1 percent by weight and about 3.5 percent by weight. For example, the aerosol-generating film may have an acid content of between about 1 percent by weight and about 3 percent by weight or between about 1 percent by weight and about 2.5 percent by weight.

The aerosol-generating film may comprise one or more flavourants. For example, the aerosol-generating film may comprise one or more flavorants selected from the group consisting of terpenes and terpenoids. For example, the aerosol-generating film may comprise menthol, eugenol or eucalyptol.

The aerosol-generating film may have a flavourant content of up to about 2 percent by weight.

The aerosol-generating film may be formed by preparing a liquid film-forming composition comprising a cellulose based film-forming agent, a non-cellulose based thickening agent and a polyhydric alcohol, casting or extruding the liquid film-forming composition onto a support, leaving the liquid film-forming composition to solidify and then drying the film-forming composition to obtain an aerosol-generating film.

Preferably, the aerosol-generating film is formed from an aqueous film-forming composition.

The heater assembly may be configured to heat the aerosol-generating film to a temperature of between about 120 degrees Celsius and about 350 degrees Celsius to generate an inhalable aerosol.

Preferably, the heater assembly is configured to heat the aerosol-generating film to a temperature of between about 180 degrees Celsius and about 250 degrees Celsius to generate an inhalable aerosol.

More preferably, the heater assembly is configured to heat the aerosol-generating film to a temperature of between about 200 degrees Celsius and about 220 degrees Celsius to generate an inhalable aerosol.

Preferably, the aerosol-generating system comprises at least about 20 milligrams of the aerosol-generating film. More preferably, the aerosol-generating system comprises at least about 50 milligrams of the aerosol-generating film. Most preferably, the aerosol-generating system comprises at least about 100 milligrams of the aerosol-generating film.

The aerosol-generating system may comprise less than equal to about than about 300 milligrams of the aerosol-generating film. For example, the aerosol-generating system may comprise less than equal to about than about 200 milligrams of the aerosol-generating film.

The aerosol-generating system may comprise between about 20 milligrams and about 300 milligrams of the aerosol-generating film. For example, the aerosol-generating system may comprise between about 20 milligrams and about 200 milligrams of the aerosol-generating film.

The aerosol-generating system may comprise between about 50 milligrams and about 300 milligrams of the aerosol-generating film. For example, the aerosol-generating system may comprise between about 50 milligrams and about 200 milligrams of the aerosol-generating film.

The aerosol-generating system may comprise between about 100 milligrams and about 300 milligrams of the aerosol-generating film. For example, the aerosol-generating system may comprise between about 100 milligrams and about 200 milligrams of the aerosol-generating film.

The heater assembly may be configured to heat the aerosol-generating film by conduction to generate an inhalable aerosol.

The heater assembly may be configured to heat the aerosol-generating film by induction to generate an inhalable aerosol.

The heater assembly may comprise one or more heating elements.

The heater assembly may comprise one or more flat surface heating elements.

The heater assembly may comprise one or more mesh heating elements.

The heater may comprise one or electrically resistive heating elements. The heater may comprise one or electrically resistive heating elements comprising one or more electrically resistive materials. Suitable electrically resistive materials include, but are not limited to, semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium- titanium- zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

The heater assembly may comprise one or more inductive heating elements. The heater assembly may comprise one or more inductive heating elements comprising an inductor and a susceptor. The inductor may generate an alternating or fluctuating electromagnetic field that induces eddy currents in the susceptor. Heat may be generated in the susceptor due to resistive losses (ohmic or resistive heating). Where the susceptor is magnetic, heat may also be generated in the susceptor due to hysteresis losses. The susceptor may heat the aerosol-generating film by conduction.

The inductor may comprise an induction coil.

The susceptor may comprise a ferromagnetic material. The susceptor may comprise a ferrite material. The susceptor may comprise a metallic material. For example, the susceptor may comprise ferritic iron, ferromagnetic steel, stainless steel, or aluminium.

The heater assembly may comprise a plurality of heating elements. The control circuitry may be configured to control a supply of power from the power supply to each of the plurality of heating elements.

In embodiments in which the heater assembly comprises a plurality of heating elements, the heating elements may be arranged to heat different portions of the aerosol-generating film. In such embodiments, the controller may be configured to activate the heating elements sequentially in response to successive user inhalations.

The control circuitry may comprise a microprocessor. The microprocessor may be a programmable microprocessor, a microcontroller, or an application specific integrated chip (ASIC) or other electronic circuitry capable of providing control.

The control circuitry may comprise further electronic components. For example, the control circuitry may comprise one or more sensors, one or more switches, one or more display elements or any combination thereof.

The control circuitry may comprise a sensor configured to detect a user inhalation. The control circuitry may be configured to activate the heater assembly to sequentially heat different portions of the aerosol-generating film in response to successive user inhalations detected by the sensor.

The control circuitry may comprise a flow sensor configured to detect air flow changes that occur when a user draws on the aerosol-generating system.

The control circuitry may comprise a pressure sensor configured to detect pressure changes that occur when a user draws on the aerosol-generating system.

The control circuitry may comprise a capacitive sensor configured to detect when a user contacts the aerosol-generating system with their lips in order to draw on the aerosol-generating system. For example, the control circuitry may comprise a capacitive sensor arranged in proximity to a mouthpiece of the aerosol-generating system.

The control circuitry may comprise a mechanism that may be activated by a user to indicate a user inhalation. For example, the control circuitry may comprise a switch that may be pressed by a user to indicate a user inhalation.

The aerosol-generating system may comprise an electrical power source.

The power source may comprise a battery. For example, the power source may comprise a lithium iron phosphate battery.

The power source may comprise a rechargeable battery or a non-rechargeable battery.

The power source may comprise another form of charge storage device. For example, the power source may comprise a capacitor.

The control circuitry may be configured to control a continuous supply of power from the power supply to the heating assembly in response to a user inhalation.

The control circuitry may be configured to control a pulsed supply of power from the power supply to the heating assembly continuously in response to a user inhalation.

The aerosol-generating film may be disposed on a support.

The aerosol-generating film may be disposed on a planar support. For example, the aerosol-generating film may be disposed on a substantially square, substantially rectangular, substantially circular planar support or substantially annular planar support.

The aerosol-generating film may be disposed on an elongate support. For example, the aerosol-generating film may be disposed on a continuous or discontinuous elongate support tape.

The aerosol-generating film may be disposed on a tubular support. For example, the aerosol-generating film may be disposed on a substantially cylindrical tubular support.

The aerosol-generating film may be disposed on a support formed of any suitable material or combination of materials. For example, the aerosol-generating film may be disposed on a paper, glass or cardboard support.

The aerosol-generating film may be disposed on a heat-conductive support. For example, the aerosol-generating film may be disposed on a support comprising metallised paper or metallised cardboard support or a support comprising a metal foil laminate.

In embodiments in which the aerosol-generating film is disposed on a support, the heating assembly may be configured to heat an outer surface of the aerosol-generating film.

As used herein with reference to the invention, the term “outer surface” is used to describe a surface of an aerosol-generating film disposed on a support that is not in contact with the support.

In embodiments in which the aerosol-generating film is disposed on a support, the heating assembly may be configured to heat an inner surface of the support. The aerosol-generating film

As used herein with reference to the invention, the term “inner surface” is used to describe a surface of a support on which an aerosol-generating film is disposed that is not contact with the aerosol-generating film.

The aerosol-generating system may comprise a drive assembly configured to move the aerosol-generating film relative to the heater assembly.

The aerosol-generating system may comprise a drive assembly configured to move the heater assembly relative to aerosol-generating film.

In embodiments in which the aerosol-generating film is disposed on a substantially circular planar support, the drive assembly may comprise a turntable on which the substantially circular planar support is mounted.

In embodiments in which the aerosol-generating film is disposed on an elongate support tape, the drive assembly may comprise one or rotatably mounted drums or reels around which at least part of the elongate support tape flexible strip is wound.

The control circuitry may be configured to activate the drive assembly between successive user inhalations.

The aerosol-generating system may comprise a plurality of spaced-apart discrete portions of the aerosol-generating film disposed on a support.

The plurality of spaced-apart discrete portions of aerosol-generating film may comprise a regular linear array of spaced-apart discrete strips or bands of aerosol-generating film.

The plurality of spaced-apart discrete portions of aerosol-generating film comprises a regular two-dimensional array of spaced-apart discrete dots or spots of aerosol-generating film.

The spaced-apart dots or spots may be of any suitable shape. For example, the spaced-apart dots or spots may be substantially circular, substantially square or substantially rectangular.

The control circuitry may be configured to activate the heater assembly to sequentially heat different spaced-apart discrete portions of the aerosol-generating film in response to successive user inhalations.

The control circuitry may be configured to activate the heater assembly to sequentially heat different groups or subsets of the plurality of spaced apart discrete portions of the aerosol-generating film in response to successive user inhalations.

The control circuitry may be configured to activate the heater assembly to sequentially heat a different one of the plurality of spaced-apart discrete portions of the aerosol-generating film in response to successive user inhalations.

Each spaced-apart discrete portion of aerosol-generating film may provide sufficient inhalable aerosol for a single puff when heated.

Each of the plurality of spaced apart discrete portions of aerosol-generating film may comprise the same amount of aerosol-generating film.

The plurality of spaced apart discrete portions of aerosol-generating film may comprise two or more groups of spaced apart discrete portions of aerosol-generating film comprising different amounts of aerosol-generating film.

Each spaced-apart discrete portion of aerosol-generating film may comprise between about 2 milligrams and about 30 milligrams of aerosol-generating film. For example, each spaced-apart discrete portion of aerosol-generating film may comprise between about 5 milligrams and about 20 milligrams of aerosol-generating film, or between about 10 milligrams and about 20 milligrams of aerosol-generating film.

Each of the plurality of spaced apart discrete portions of aerosol-generating film may have the same composition.

The plurality of spaced apart discrete portions of aerosol-generating film may comprise two or more groups of spaced apart discrete portions of aerosol-generating film of different composition.

For example, the plurality of spaced apart discrete portions of aerosol-generating film may comprise: a first group of spaced apart discrete portions of an aerosol-generating film comprising a cellulose based film-forming agent, a non-cellulose based thickening agent, a polyhydric alcohol and nicotine; and a second group of spaced apart discrete portions of an aerosol-generating film comprising a cellulose based film-forming agent, a non-cellulose based thickening agent, a polyhydric alcohol and a flavourant.

Each spaced-apart discrete portion of aerosol-generating film may comprise between about 90 micrograms and about 1200 micrograms of polyhydric alcohol. For example, each spaced-apart discrete portion of aerosol-generating film may comprise between about 90 micrograms and about 1000 micrograms of polyhydric alcohol or between about 90 micrograms and about 900 micrograms of polyhydric alcohol. For example, each spaced-apart discrete portion of aerosol-generating film may comprise between about 150 micrograms and about 850 micrograms of polyhydric alcohol, between about 150 micrograms and about 800 micrograms of polyhydric alcohol or between about 150 micrograms and about 750 micrograms of polyhydric alcohol.

Preferably, each spaced-apart discrete portion of aerosol-generating film comprises between about 200 micrograms and about 750 micrograms of polyhydric alcohol. For example, each spaced-apart discrete portion of aerosol-generating film may comprise between about 200 micrograms and about 700 micrograms of polyhydric alcohol, between about 200 micrograms and about 650 micrograms of polyhydric alcohol or between about 200 micrograms and about 600 micrograms of polyhydric alcohol.

More preferably, each spaced-apart discrete portion of aerosol-generating film comprises between about 250 micrograms and about 600 micrograms of polyhydric alcohol. For example, each spaced-apart discrete portion of aerosol-generating film may comprise between about 250 micrograms and about 550 micrograms of polyhydric alcohol, between about 250 micrograms and about 500 micrograms of polyhydric alcohol or between about 250 micrograms and about 450 micrograms of polyhydric alcohol.

Most preferably, each spaced-apart discrete portion of aerosol-generating film comprises between about 300 micrograms and about 450 micrograms of polyhydric alcohol. For example, each spaced-apart discrete portion of aerosol-generating film may comprise between about 300 micrograms and about 400 micrograms of polyhydric alcohol or between about 300 micrograms and about 350 micrograms of polyhydric alcohol.

In embodiments in which the aerosol-generating film comprises nicotine, each spaced-apart discrete portion of aerosol-generating film may comprise between about 20 micrograms and about 150 micrograms of nicotine. For example, each spaced-apart discrete portion of aerosol-generating film may comprise between about 20 micrograms and about 125 micrograms of nicotine or between about 50 micrograms and about 125 micrograms of nicotine. For example, each spaced-apart discrete portion of aerosol-generating film may comprise between about 20 micrograms and about 100 micrograms of nicotine or between about 50 micrograms and about 100 micrograms of nicotine. For example, each spaced-apart discrete portion of aerosol-generating film may comprise between about 20 micrograms and about 75 micrograms of nicotine or between about 50 micrograms and about 75 micrograms of nicotine.

The aerosol-generating system may comprise between about 2 and about 40 spaced-apart discrete portions of aerosol-generating film disposed on a support.

In certain embodiments, the number of spaced-apart discrete spaced-apart portions of aerosol-generating film disposed on the support may be equal to the average number of puffs for a combustible cigarette. For example, the aerosol-generating system may comprise between about 7 and about 10 spaced-apart discrete portions of aerosol-generating film disposed on a support.

In certain embodiments, the support may comprise one or more lines of perforations or other lines of weakness to enable a user to allow a user to select a desired number of spaced-apart discrete portions of aerosol-generating film.

The aerosol-generating system may comprise: an aerosol-generating article comprising the aerosol-generating film; and an aerosol-generating device comprising the power supply and the control circuitry.

As used herein with reference to the invention, the term “aerosol-generating article” is used to describe an article comprising an aerosol-generating film that is intended to be heated rather than combusted in order to release volatile compounds that can form an aerosol.

As used herein with reference to the invention, the term “aerosol-generating device” is used to describe a device that interacts with an aerosol-generating article to generate an aerosol.

The aerosol-generating system may advantageously comprise: a consumable aerosol-generating article comprising the aerosol-generating film; and a reusable aerosol-generating device comprising the power supply and the control circuitry.

The aerosol-generating system may comprise: an aerosol-generating article comprising the aerosol-generating film; and an aerosol-generating device comprising the heater assembly, the power supply and the control circuitry.

The aerosol-generating system may comprise: an aerosol-generating article comprising the aerosol-generating film and the heater assembly; and an aerosol-generating device comprising the power supply and the control circuitry.

Where applicable, features described in relation to the aerosol-generating system according to the first aspect of the invention may equally be applied to the aerosol-generating article according to the second of the invention and vice versa.

The invention will be further described, by way of example only, with reference to the accompanying drawings, in which:

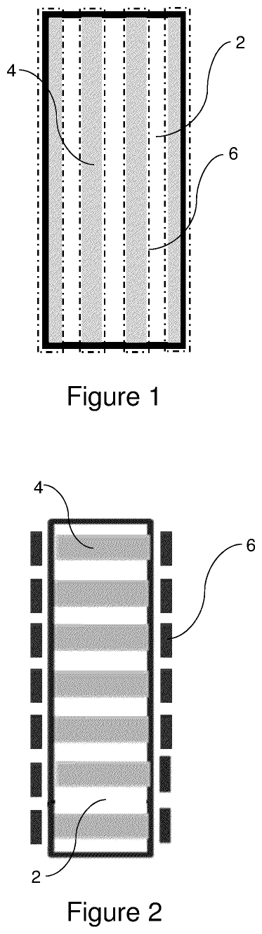

FIG. 1 shows a schematic front plan view of an aerosol-generating system according to a first embodiment of the invention comprising an aerosol-generating article according to a first embodiment of the invention;

FIG. 2 shows a schematic front plan view of an aerosol-generating system according to a second embodiment of the invention comprising an aerosol-generating article according to a second embodiment of the invention;

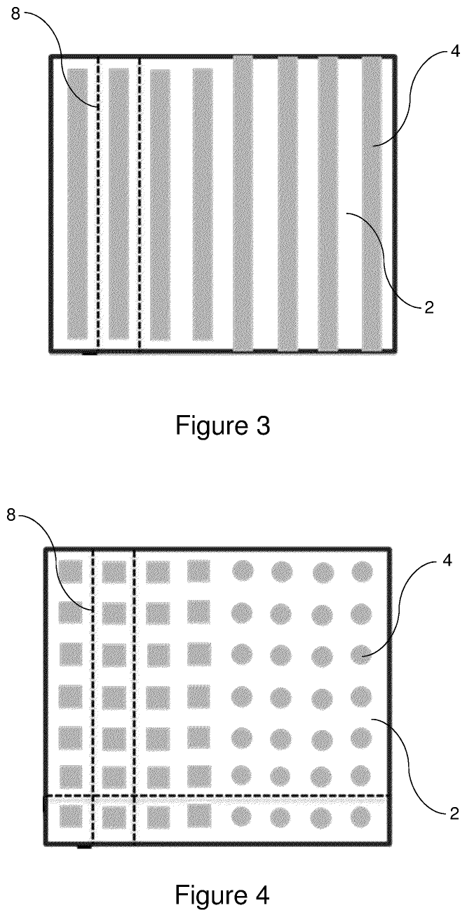

FIG. 3 shows a schematic view top plan view of an aerosol-generating system according to a third embodiment of the invention comprising an aerosol-generating article according to a third embodiment of the invention;

FIG. 4 shows a schematic top plan view of an aerosol-generating system according to a fourth embodiment of the invention comprising an aerosol-generating article according to a fourth embodiment of the invention;

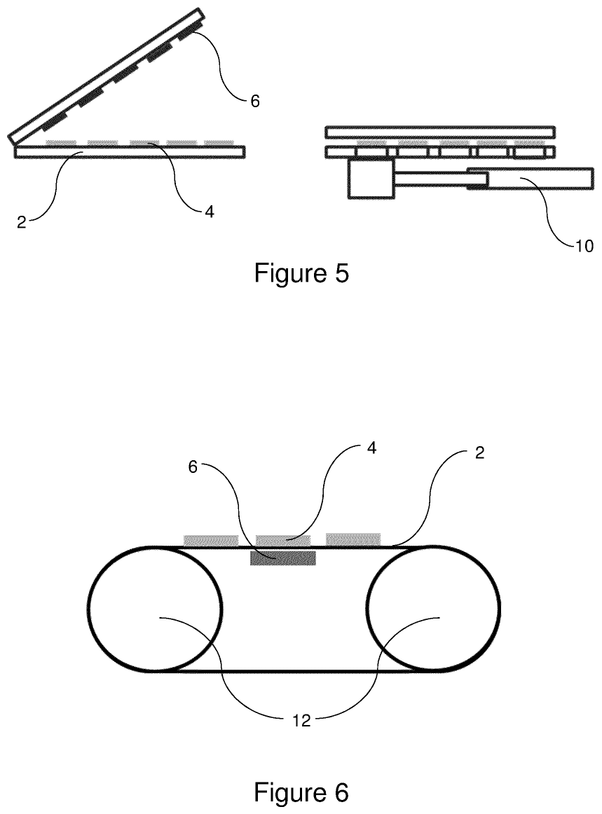

FIG. 5 shows schematic transverse cross-sectional views of an aerosol-generating system according to a fifth embodiment of the invention comprising an aerosol-generating article according to a fifth embodiment of the invention;

FIG. 6 shows a schematic transverse cross-sectional view of an aerosol-generating system according to a sixth embodiment of the invention comprising an aerosol-generating article according to a sixth embodiment of the invention;

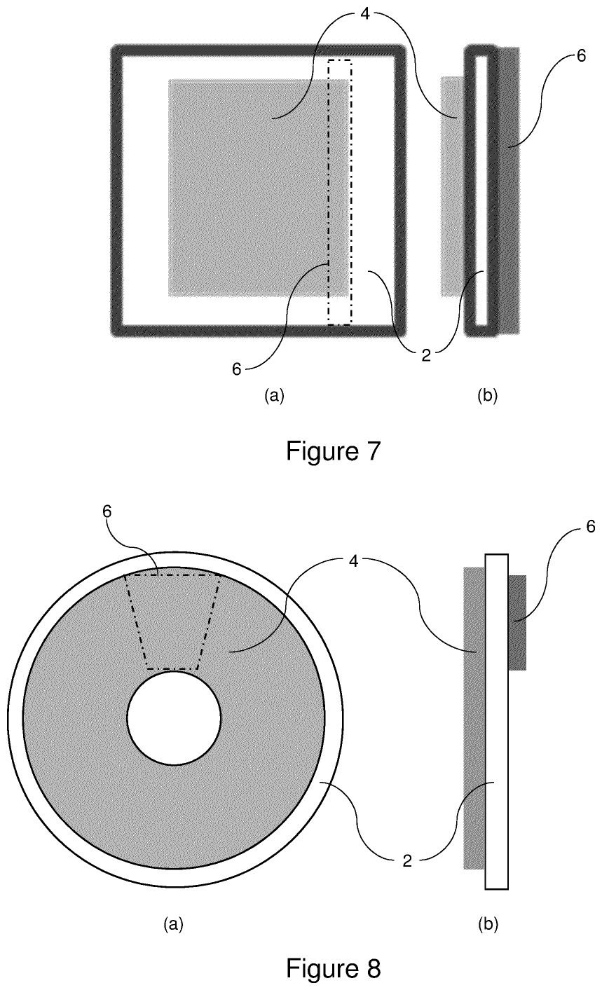

FIG. 7 shows (a) a schematic top plan view and (b) a schematic right-side elevational view of an aerosol-generating system according to an seventh embodiment of the invention; and

FIG. 8 shows 8 shows (a) a schematic top plan view and (b) a schematic right-side elevational view of an aerosol-generating system according to an eighth embodiment of the invention.

The aerosol-generating system according to the first embodiment of the invention shown in FIG. 1 comprises a consumable aerosol-generating article according to a first embodiment of the invention and a reusable aerosol-generating device.

The consumable aerosol-generating article according to the first embodiment of the invention comprises a tubular cylindrical support 2 and a plurality of longitudinally extending, circumferentially spaced-apart discrete portions or bands of aerosol-generating film 4 disposed on the outer curved surface of the tubular cylindrical support 2. The tubular cylindrical support 2 may have a length of, for example, between about 30 mm about 150 mm and an external diameter of, for example, between about 5 mm about 15 mm.

Each of the plurality of longitudinally extending, circumferentially spaced-apart discrete bands of aerosol-generating film 4 comprises 20 mg of aerosol-generating film having the composition shown in Table 1:

TABLE 1

| | Content |
|---|---|
| Component: | (weight percent) |
| HPMC (cellulose based film-forming agent) | 19.3 |
| Agar (non-cellulose based thickening agent) | 4.8 |
| Glycerine (polyhydric alcohol) | 48 |
| Nicotine | 1.4 |
| Levulinic acid | 2.1 |
| Water | 24.4 |

The composition and quantity of the aerosol-generating film in each of the longitudinally extending, circumferentially spaced-apart discrete bands of aerosol-generating film 4 is the same. The aerosol-generating film in each of the longitudinally extending, circumferentially spaced-apart discrete bands of aerosol-generating film 4 comprises a cellulose based film-forming agent, a non-cellulose based thickening agent and a polyhydric alcohol. The quantity of aerosol-generating film in each of the longitudinally extending, circumferentially spaced-apart discrete bands of aerosol-generating film 4 is such that each longitudinally extending, circumferentially spaced-apart discrete band of aerosol-generating film 4 provides sufficient inhalable aerosol for a single puff when heated.

The reusable aerosol-generating device comprises a heater assembly comprising a plurality of fixed elongate heating elements 6 for heating the plurality of longitudinally extending, circumferentially spaced-apart discrete bands of aerosol-generating film 4 to generate an inhalable aerosol. The plurality of fixed elongate heating elements 6 (shown by dashed and dotted lines in FIG. 1) are circumferentially spaced-apart about the periphery of the outer curved surface the tubular cylindrical support 2 so that each of the plurality of fixed elongate heating elements 6 is disposed adjacent to the outer surface of a different one of the longitudinally extending, circumferentially spaced-apart discrete bands of aerosol-generating film 4. The plurality of fixed elongate heating elements 6 may be flat surface heaters or mesh heaters.

The reusable aerosol-generating device further comprises a power supply and control circuitry (not shown).

The control circuitry is configured to control a supply of power from the power supply to each of the plurality of fixed elongate heating elements 6. The control circuitry comprises a flow sensor (not shown) configured to detect air flow changes that occur when a user draws on the aerosol-generating system. The control circuitry is configured to activate the plurality of fixed elongate heating elements 6 sequentially in response to successive user inhalations detected by the flow sensor to sequentially heat a different one of the longitudinally extending, circumferentially spaced-apart discrete bands of aerosol-generating film 4 in response to successive user inhalations.

It will be appreciated that in alternative embodiments the aerosol-generating article may comprise a continuous layer of aerosol generating film disposed on the outer curved surface of the tubular cylindrical support 2, rather than a plurality of longitudinally extending, circumferentially spaced-apart discrete bands of aerosol-generating film 4.

The consumable aerosol-generating system according to the second embodiment of the invention shown in FIG. 2 comprises a consumable aerosol-generating article according to a second embodiment of the invention and a reusable aerosol-generating device.

The aerosol-generating article according to the second embodiment of the invention comprises a tubular cylindrical support 2 and a plurality of circumferentially extending, longitudinally spaced-apart discrete portions or rings of aerosol-generating film 4 disposed on the outer curved surface of the tubular cylindrical support 2. The tubular cylindrical support 2 may have a length of, for example, between about 5 mm about 150 mm and an external diameter of, for example, between about 5 mm about 15 mm. Depending upon the dimensions of the tubular cylindrical support 2, up to, for example, 40 circumferentially extending, longitudinally spaced-apart discrete rings of aerosol-generating film 4 may be disposed on the outer curved surface of the tubular cylindrical support 2.

The composition and quantity of the aerosol-generating film in each of the circumferentially extending, longitudinally spaced-apart discrete rings of aerosol-generating film 4. The aerosol-generating film in each of the circumferentially extending, longitudinally spaced-apart discrete rings of aerosol-generating film 4 comprises a cellulose based film-forming agent, a non-cellulose based thickening agent and a polyhydric alcohol. The quantity of aerosol-generating film in each of the circumferentially extending, longitudinally spaced-apart discrete rings of aerosol-generating film 4 is such that each circumferentially extending, longitudinally spaced-apart discrete ring of aerosol-generating film 4 provides sufficient inhalable aerosol for a single puff when heated.

The reusable aerosol-generating device comprises a heater assembly comprising a plurality of fixed annular heating elements 6 for heating the circumferentially extending, longitudinally spaced-apart discrete rings of aerosol-generating film 4 to generate an inhalable aerosol. The plurality of fixed annular heating elements 6 are longitudinally spaced-apart about the periphery of the outer curved surface the tubular cylindrical support 2 so that each of the plurality of fixed annular heating elements 6 is disposed adjacent to the outer surface of a different one of the circumferentially extending, longitudinally spaced-apart discrete rings of aerosol-generating film 4. The plurality of fixed annular heating elements 6 may be flat surface heaters or mesh heaters.

The reusable aerosol-generating device further comprises a power supply and control circuitry (not shown).

The control circuitry is configured to control a supply of power from the power supply to each of the plurality of fixed annular heating elements 6. The control circuitry comprises a flow sensor (not shown) configured to detect air flow changes that occur when a user draws on the aerosol-generating system. The control circuitry is configured to activate the plurality of fixed annular heating elements 6 sequentially in response to successive user inhalations detected by the flow sensor to sequentially heat a different one of the circumferentially extending, longitudinally spaced-apart discrete rings of aerosol-generating film 4 in response to successive user inhalations.

It will be appreciated that in alternative embodiments the aerosol-generating article may comprise a continuous layer of aerosol generating film disposed on the outer curved surface of the tubular cylindrical support 2, rather than a plurality of circumferentially extending, longitudinally spaced-apart discrete rings of aerosol-generating film 4.

The aerosol-generating system according to the third embodiment of the invention shown in FIG. 3 comprises a consumable aerosol-generating article according to a third embodiment of the invention and a reusable aerosol-generating device.

The consumable aerosol-generating article according to the third embodiment of the invention comprises a planar support 2 and a regular linear array of spaced-apart discrete strips of aerosol-generating film 4 disposed on the upper surface of the planar support 2. The spaced-apart discrete strips of aerosol-generating film 4 may have width of, for example, between about 2 mm and about 20 mm and a length of, for example, between about 5 mm about 50 mm. Depending upon the dimensions of the planar support 2, up to, for example, 40 spaced-apart discrete strips of aerosol-generating film 4 may be disposed on the upper surface of the planar support 2.

The composition and quantity of the aerosol-generating film in each of the spaced-apart discrete strips of aerosol-generating film 4 is the same. The aerosol-generating film in each of the spaced-apart discrete strips of aerosol-generating film 4 comprises a cellulose based film-forming agent, a non-cellulose based thickening agent and a polyhydric alcohol. The quantity of aerosol-generating film in each of the spaced-apart discrete strips of aerosol-generating film 4 is such that each spaced-apart discrete strip of aerosol-generating film 4 provides sufficient inhalable aerosol for a single puff when heated.

The reusable aerosol-generating device comprises a heater assembly comprising a plurality of fixed elongate heating elements (not shown) for heating the regular linear array of spaced-apart discrete strips of aerosol-generating film 4 to generate an inhalable aerosol. The plurality of fixed elongate heating elements are disposed adjacent to the lower surface of the planar support 2 and are spaced-apart so that each of the plurality of fixed elongate heating elements is situated directly below a different one of the spaced-apart discrete strips of aerosol-generating film 4. The plurality of fixed elongate heating elements may be flat surface heaters or mesh heaters.

The reusable aerosol-generating device further comprises a power supply and control circuitry (not shown).

The control circuitry is configured to control a supply of power from the power supply to each of the plurality of fixed elongate heating elements. The control circuitry comprises a flow sensor (not shown) configured to detect air flow changes that occur when a user draws on the aerosol-generating system. The control circuitry is configured to activate the plurality of fixed elongate heating elements sequentially in response to successive user inhalations detected by the flow sensor to sequentially heat a different one of the spaced-apart discrete strips of aerosol-generating film 4 in response to successive user inhalations.

As shown in FIG. 3, lines of perforations 8 or other lines of weakness may be provided in the planar support 2 between the spaced-apart discrete strips of aerosol-generating film 4 to allow a user to select a desired number of spaced-apart discrete strips of aerosol-generating film 4 to heat and hence a desired number of puffs and a desired total aerosol delivery.

The aerosol-generating system according to the fourth embodiment of the invention shown in FIG. 4 comprises a consumable aerosol-generating article according to a fourth embodiment of the invention and a reusable aerosol-generating device.

The consumable aerosol-generating article according to the fourth embodiment of the invention shown in FIG. 4 is similar to the aerosol-generating article according to the third embodiment of the invention shown in FIG. 2, but comprises a regular two dimensional array of spaced-apart discrete dots of aerosol-generating film 4 disposed on the planar support 2 rather than a regular linear array of spaced-apart discrete strips of aerosol-generating film.

As shown in FIG. 4, the spaced-apart dots of aerosol-generating film 4 may be substantially square or substantially circular. The spaced-apart dots of aerosol-generating film 4 may have a surface area of, for example, between about 25 mm² and about 400 mm² and a length of, for example, between about 5 mm about 50 mm. Depending upon the dimensions of the planar support 2, up to, for example, 40 spaced-apart discrete dots of aerosol-generating film 4 may be disposed on the upper surface of the planar support 2.

The reusable aerosol-generating device comprises a heater assembly comprising a plurality of fixed heating elements (not shown) for heating the regular two dimensional array of spaced-apart discrete dots of aerosol-generating film 4 to generate an inhalable aerosol. The plurality of fixed heating elements are disposed adjacent to the lower surface of the planar support 2 and are spaced-apart so that each of the plurality of fixed heating elements is situated directly below a different one of the spaced-apart discrete dots of aerosol-generating film 4. The plurality of fixed elongate heating elements may be flat surface heaters or mesh heaters.

The reusable aerosol-generating device further comprises a power supply and control circuitry (not shown).

The control circuitry is configured to control a supply of power from the power supply to each of the plurality of fixed elongate heating elements. The control circuitry comprises a flow sensor (not shown) configured to detect air flow changes that occur when a user draws on the aerosol-generating system. The control circuitry is configured to activate the plurality of fixed heating elements sequentially in response to successive user inhalations detected by the flow sensor to sequentially heat a different one of the spaced-apart discrete dots of aerosol-generating film 4 in response to successive user inhalations.

As shown in FIG. 4, lines of perforations 8 or other lines of weakness may be provided in the planar support 2 between the spaced-apart discrete dots of aerosol-generating film 4 to allow a user to select a desired number of spaced-apart discrete dots of aerosol-generating film 4 to heat and hence a desired number of puffs and a desired total aerosol delivery.

It will be appreciated that in an alternative embodiments the heater assembly may comprise a plurality of fixed elongate heating elements for heating the regular two dimensional array of spaced-apart discrete dots of aerosol-generating film 4 to generate an inhalable aerosol. The plurality of fixed elongate heating elements may be disposed adjacent to the lower surface of the planar support 2 and spaced-apart so that each of the plurality of fixed elongate heating elements is situated directly below a different row or column of the spaced-apart discrete dots of aerosol-generating film 4. The control circuitry may be configured to activate the plurality of fixed elongate heating elements sequentially in response to successive user inhalations detected by the flow sensor to sequentially heat a different row or column of the spaced-apart discrete dots of aerosol-generating film 4 in response to successive user inhalations.

The aerosol-generating system according to the fifth embodiment of the invention shown in FIG. 6 comprises a consumable aerosol-generating article according to a fifth embodiment of the invention and a reusable aerosol-generating device.

The consumable aerosol-generating article according to a fifth embodiment of the invention shown in FIG. 5 is the same as the aerosol-generating article according to the third embodiment of the invention shown in FIG. 3 and comprises a planar support 2 and a regular linear array of spaced-apart discrete strips of aerosol-generating film 4 disposed on the upper surface of the planar support 2.

The reusable aerosol-generating device comprises a heater assembly comprising a plurality of elongate heating elements 6 for heating the regular linear array of spaced-apart discrete strips of aerosol-generating film 4 to generate an inhalable aerosol. The heating assembly is hinged to the planar support 2. By pivoting the heating assembly, the elongate heating elements 6 may be positioned adjacent to the upper surface of the planar support 2 and are spaced-apart so that each of the plurality of elongate heating elements is situated directly above a different one of the spaced-apart discrete strips of aerosol-generating film 4. The plurality of elongate heating elements may be flat surface heaters or mesh heaters.

The reusable aerosol-generating device further comprises a power supply and control circuitry (not shown).

The control circuitry is configured to control a supply of power from the power supply to each of the plurality of fixed elongate heating elements. The control circuitry comprises a flow sensor 10 configured to detect air flow changes that occur when a user draws on the aerosol-generating system. The control circuitry is configured to activate the plurality of elongate heating elements sequentially in response to successive user inhalations detected by the flow sensor to sequentially heat a different one of the spaced-apart discrete strips of aerosol-generating film 4 in response to successive user inhalations.

The aerosol-generating system according to the sixth embodiment of the invention shown in FIG. 6 comprises a consumable aerosol-generating article according to a sixth embodiment of the invention and a reusable aerosol-generating device.

The consumable aerosol-generating article according to the sixth embodiment of the invention comprises a continuous elongate support tape 2 and a plurality of longitudinally spaced-apart discrete portions of aerosol-generating film 4 disposed on the outer surface of the continuous elongate support tape 2. As shown in FIG. 6, the continuous elongate support tape 2 is trained around a pair of spaced-apart drums or wheels 12. The wheels 12 may have an external diameter of, for example, between about 20 mm and about 80 mm. The continuous elongate support tape 2 may have a length of, for example, between about 150 mm about 650 mm. Depending upon the dimensions of the continuous elongate support tape 2, up to, for example, 40 longitudinally spaced-apart discrete portions of aerosol-generating film 4 may be disposed on the outer surface of the elongate support tape 2.

The composition and quantity of the aerosol-generating film in each of the longitudinally spaced-apart discrete portions of aerosol-generating film 4 is the same. The aerosol-generating film in each of the longitudinally spaced-apart discrete portions of aerosol-generating film 4 comprises a cellulose based film-forming agent, a non-cellulose based thickening agent and a polyhydric alcohol. The quantity of aerosol-generating film in each of the longitudinally spaced-apart discrete portions of aerosol-generating film 4 is such that each longitudinally spaced-apart discrete portion of aerosol-generating film 4 provides sufficient inhalable aerosol for a single puff when heated.

The reusable aerosol-generating device comprises a heater assembly comprising a heating element 6 for heating the aerosol-generating film 4 to generate an inhalable aerosol. The heating element 6 is disposed adjacent to the inner surface of the continuous elongate support tape 2. The heating element 6 may be a flat surface heater or a mesh heater.

The reusable aerosol-generating device further comprises a power supply, control circuitry and a drive assembly (not shown).

The drive assembly is configured to drive one or both of the wheels 12 to move the continuous elongate support tape 2 relative to the heating element 6.

The control circuitry comprises a flow sensor (not shown) configured to detect air flow changes that occur when a user draws on the aerosol-generating system. The control circuitry is configured to control a supply of power from the power supply to the heating element 6 in response to a user inhalation detected by the flow sensor. The control circuitry is configured to activate the drive assembly between successive user inhalations to move the continuous elongate support tape 2 relative to the heating element 6 between successive user inhalations. By moving the continuous elongate support tape 2 relative to the heating element 6 between successive user inhalations, the control circuitry is configured to activate the heating element 6 to sequentially heat different longitudinally spaced-apart portions of the aerosol-generating film 4 disposed on the outer surface of the continuous elongate support tape 2 in response to successive user inhalations.

It will be appreciated that in alternative embodiments the aerosol-generating article may comprise a continuous layer of aerosol generating film disposed on the outer surface of the elongate support tape 2, rather than a plurality of longitudinally spaced-apart discrete portions of aerosol-generating film 4.

It will also be appreciated that in alternative embodiments the elongate support tape 2 may be wound on a supply reel and attached to a take-up reel, which is initially empty and which is driven by the drive assembly to move the continuous elongate support tape 2 relative to the heating element 6. In such embodiments, the reusable aerosol-generating article may resemble a cassette tape.

It will also be appreciated that in alternative embodiments the aerosol-generating film may be disposed on the outer surface of a discontinuous elongate support tape.

It will further be appreciated that in an alternative embodiments the consumable aerosol-generating article may comprise the heater assembly comprising the heating element, rather than the reusable aerosol-generating device.

The aerosol-generating system according to the seventh embodiment of the invention shown in FIG. 7 comprises a consumable aerosol-generating article and a reusable aerosol-generating device.

The consumable aerosol-generating article comprises a planar substantially square support 2 and an aerosol-generating film 4 disposed on the upper surface of the planar substantially square support 2. The planar substantially square support 2 may have a length and a width of, for example, between about 5 mm about 80 mm.

The aerosol-generating film 4 comprises a cellulose based film-forming agent, a non-cellulose based thickening agent and a polyhydric alcohol.

The reusable aerosol-generating device comprises a heater assembly comprising a planar rectangular heating element 6 for heating the aerosol-generating film 4 to generate an inhalable aerosol. The planar rectangular heating element 6 (shown by a dashed and dotted line in the (a) schematic top plan view in FIG. 7) is disposed adjacent to the lower surface of the planar substantially square support 2. The planar rectangular heating element 6 may be a flat surface heater or a mesh heater.

The reusable aerosol-generating device further comprises a power supply, control circuitry and a drive assembly (not shown).

The drive assembly is configured to move the planar rectangular heating element 6 relative to the planar substantially square support 2.

The control circuitry comprises a flow sensor (not shown) configured to detect air flow changes that occur when a user draws on the aerosol-generating system. The control circuitry is configured to control a supply of power from the power supply to the planar rectangular heating element 6 in response to a user inhalation detected by the flow sensor. The control circuitry is configured to activate the drive assembly between successive user inhalations to move the planar rectangular heating element 6 relative to the planar substantially square support 2 between successive user inhalations. By moving the planar rectangular heating element 6 relative to the planar substantially square support 2 between successive user inhalations, the control circuitry is configured to activate the planar rectangular heating element 6 to sequentially heat different portions of the aerosol-generating film 4 disposed on the upper surface of the planar substantially square support 2 in response to successive user inhalations.

It will be appreciated that in an alternative embodiments the planar support 2 may be a different shape. For example, the planar support 2 may be substantially rectangular or substantially circular.

It will also be appreciated that in alternative embodiments the control circuitry and drive assembly may be configured to move the planar support 2 relative to the planar heating element 6 between successive user inhalations.

The aerosol-generating system according to the eighth embodiment of the invention shown in FIG. 8 comprises a consumable aerosol-generating article and a reusable aerosol-generating device.

The consumable aerosol-generating article comprises a planar annular support 2 and an aerosol-generating film 4 disposed on the upper surface of the planar annular support 2. The aerosol-generating film 4 comprises a cellulose based film-forming agent, a non-cellulose based thickening agent and a polyhydric alcohol. The planar annular support 2 may have an external diameter of, for example, between about 30 mm about 150 mm.

The reusable aerosol-generating device comprises a heater assembly comprising a planar trapezoidal heating element 6 for heating the aerosol-generating film 4 to generate an inhalable aerosol. The planar trapezoidal heating element 6 (shown by a dashed and dotted line in the (a) schematic top plan view in FIG. 8) is disposed adjacent to the lower surface of the planar annular support 2. The planar trapezoidal heating element 6 may be a flat surface heater or a mesh heater.

The reusable aerosol-generating device further comprises a power supply, control circuitry and a drive assembly (not shown).

The drive assembly is configured to rotate the planar annular support 2 relative to the planar trapezoidal heating element 6.

The control circuitry comprises a flow sensor (not shown) configured to detect air flow changes that occur when a user draws on the aerosol-generating system. The control circuitry is configured to control a supply of power from the power supply to the planar trapezoidal heating element 6 in response to a user inhalation detected by the flow sensor. The control circuitry is configured to activate the drive assembly between successive user inhalations to rotate the planar annular support 2 relative to the planar trapezoidal heating element 6 between successive user inhalations. By rotating the planar annular support 2 relative to the planar trapezoidal heating element 6 between successive user inhalations, the control circuitry is configured to activate the planar trapezoidal heating element 6 to sequentially heat different portions of the aerosol-generating film 4 disposed on the upper surface of the planar annular support 2 in response to successive user inhalations.

It will be appreciated that in alternative embodiments the control circuitry and drive assembly may be configured to rotate the planar trapezoidal heating element 6 relative to the annular support 2 between successive user inhalations.

1.-15. (canceled)

16. An aerosol-generating system, comprising:
an aerosol-generating film comprising a cellulose based film-forming agent, a non-cellulose based thickening agent, and a polyhydric alcohol;
a heater assembly configured to heat the aerosol-generating film to generate an inhalable aerosol;
a power supply; and
control circuitry configured to:
control a supply of power from the power supply to the heater assembly in response to a user inhalation, and
activate the heater assembly to sequentially heat different portions of the aerosol-generating film in response to successive user inhalations,
wherein the cellulose based film-forming agent is a cellulose ether.

17. The aerosol-generating system according to claim 16, wherein the heater assembly comprises a plurality of heating elements and the control circuitry is further configured to control the supply of power from the power supply to each of the plurality of heating elements.

18. The aerosol-generating system according to claim 17, wherein the heating elements are arranged to heat different portions of the aerosol-generating film and the controller is further configured to activate the heating elements sequentially in response to successive user inhalations.

19. The aerosol-generating system according to claim 16, further comprising a drive assembly configured to move the aerosol-generating film relative to the heater assembly.

20. The aerosol-generating system according to claim 16, further comprising a drive assembly configured to move the heater assembly relative to aerosol-generating film.

21. The aerosol-generating system according to claim 19, wherein the control circuitry is further configured to activate the drive assembly between successive user inhalations.

22. The aerosol-generating system according to claim 16, further comprising a plurality of spaced-apart discrete portions of the aerosol-generating film disposed on a support.

23. The aerosol-generating system according to claim 22, wherein the control circuitry is further configured to activate the heater assembly to sequentially heat different spaced-apart discrete portions of the aerosol-generating film in response to successive user inhalations.

24. The aerosol-generating system according to claim 23, wherein the control circuitry is further configured to activate the heater assembly to sequentially heat a different one of the plurality of spaced-apart discrete portions of the aerosol-generating film in response to successive user inhalations.

25. An aerosol-generating article, comprising:
a support; and
a plurality of spaced-apart discrete portions of aerosol-generating film disposed on the support,
wherein each spaced-apart discrete portion of aerosol-generating film comprises a cellulose based film-forming agent, a non-cellulose based thickening agent, and a polyhydric alcohol, and
wherein the cellulose based film-forming agent is a cellulose ether.

26. The aerosol-generating article according to claim 25, wherein the plurality of spaced-apart discrete portions of aerosol-generating film comprises a regular linear array of spaced-apart discrete strips or bands of aerosol-generating film.

27. The aerosol-generating article according to claim 25, wherein the plurality of spaced-apart discrete portions of aerosol-generating film comprises a regular two-dimensional array of spaced-apart discrete dots or spots of aerosol-generating film.

28. The aerosol-generating article according to claim 25, wherein said each spaced-apart discrete portion of aerosol-generating film provides sufficient inhalable aerosol for a single puff when heated.

29. The aerosol-generating article according to claim 25, wherein said each spaced-apart discrete portion of aerosol-generating film has a polyhydric alcohol content of at least about 40 percent by weight.

30. The aerosol-generating article according to claim 25, wherein said each spaced-apart discrete portion of aerosol-generating film has a nicotine content of at least about 0.5 percent by weight.
